(19) United States
(12) Patent Application Publication
(10) Pub. No.: US 2003/0112154 A1
(43) Pub. Date: Jun. 19, 2003

(54) Parking location identification

(76) Inventors: John H. Yoakum, Cary, NC (US); Russell C. Coffin, Plano, TX (US); Samuel H. Christie IV, Cary, NC (US)

Correspondence Address: WITHROW & TERRANOVA, P.L.L.C., P.O. BOX 1287, CARY, NC, 27512, US

(21) Appl. No.: 10/025,704

(22) Filed: Dec. 18, 2001

(51) Int. Cl. G08G 1/14; B60Q 1/48

(52) U.S. Cl. 340/932.2

(57) ABSTRACT

The present invention provides for identifying available parking via a mobile terminal, such as a mobile telephone, personal digital assistant, or the like. A service provider is used to receive a request initiated by a mobile terminal to identify available parking, determine a location of the mobile terminal, and identify available parking based on the location of the mobile terminal. Upon identifying the available parking, parking information is then delivered to the mobile terminal for the mobile terminal's user to view or hear. The parking information can be accompanied by relevant maps, directions, and pricing information. A parking space reservation system can be incorporated to further extend the functionality.

### FIELD OF THE INVENTION

The present invention relates to identifying available parking locations, and in particular, to identifying available parking locations via a wireless communication system.

### BACKGROUND OF THE INVENTION

Locating open parking spaces along streets and in parking facilities is a challenging and frequently frustrating task. Motorists often have difficulty identifying and locating parking facilities and streets that allow parking. Unfortunately, once an acceptable street or parking facility is identified and approached, the motorist is often unable to find an available space.

Accordingly, there is a need for a way in which motorists can identify parking areas and facilities with open spaces and within a reasonable proximity of the motorist. There is a further need for a way to reserve an available space in advance of reaching the parking area or facility.

### SUMMARY OF THE INVENTION

The present invention provides for identifying available parking via a mobile terminal, such as a mobile telephone, personal digital assistant, or the like. A service provider is used to receive a request initiated by a mobile terminal to identify available parking, determine a location of the mobile terminal, and identify available parking based on the location of the mobile terminal. Upon identifying the available parking, parking information is then delivered to the mobile terminal for the mobile terminal's user to view or hear. The parking information can be accompanied by relevant maps, directions, and pricing information.

In one embodiment, the location of the mobile terminal can be expanded into an associated area of interest, which is used to identify parking areas or facilities within the area of interest. From these parking areas and facilities, available parking is identified. The area of interest can be created in any manner desired that is beneficial to the user and may also be impacted based on the direction the user is traveling. Further, the user's parking preferences can be stored in a profile and used by the service provider to select available parking suitable to the user.

The invention also supports the reservation of available parking upon receiving a request initiated by the mobile terminal to reserve parking. Preferably, confirmation of the reservation is received from the parking facility or agent thereof and forwarded to the mobile terminal, wherein confirmation indicia can be provided to a parking area or facility via the mobile terminal to confirm the reservation.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a communication environment according to one embodiment of the present invention.

FIG. 2 is a block representation of an architecture for a mobile terminal according to one embodiment of the present invention.

FIG. 3 is a block representation of an application server according to one embodiment of the present invention.

FIG. 4 illustrates numerous possible parking environments according to the present invention.

FIGS. 5A and 5B is a flow diagram illustrating operation of one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

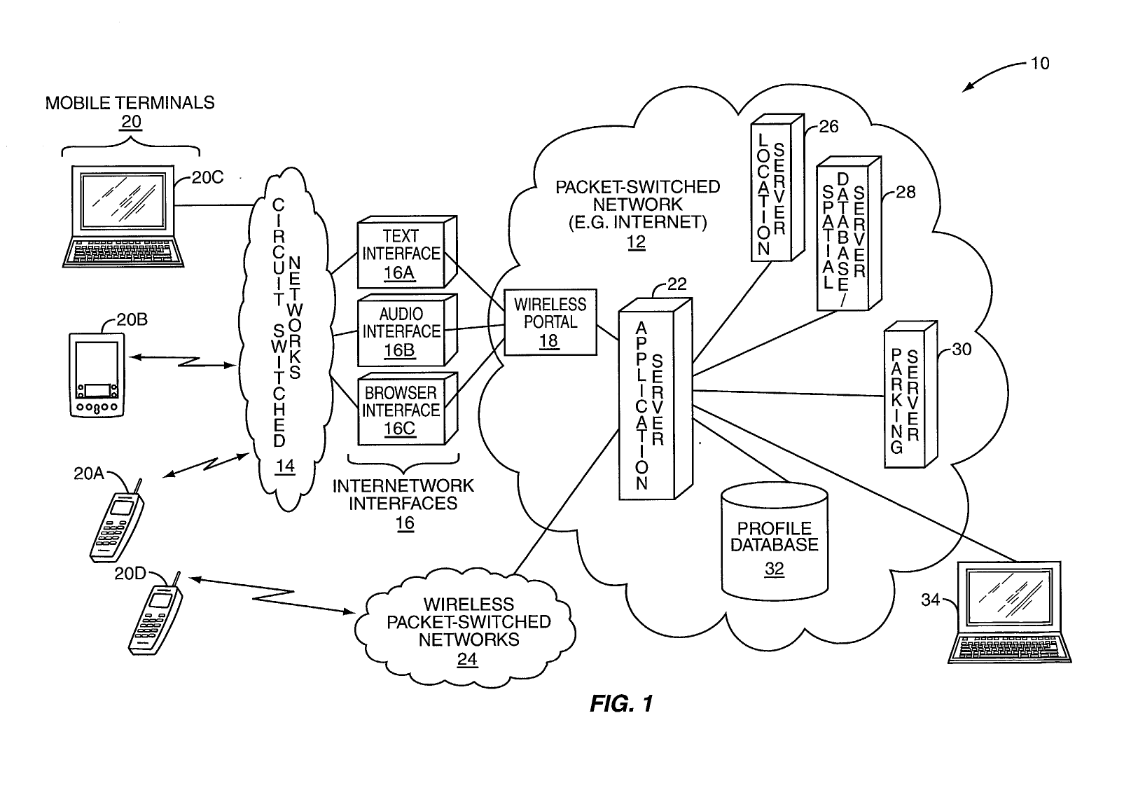

A communication environment 10 is illustrated in FIG. 1 to include a packet-switched network 12, such as the Internet, and circuit-switched networks 14, cooperating with one another via various internetwork front ends 16 to facilitate communications between the networks and various devices connected thereto. Those skilled in the art will recognize that the packet-switched network 12 may include numerous networks connected to each other via hubs, routers, and switches to facilitate packet-switched communications. Further, the circuit-switched networks 14 will typically include the Public Switched Telephone Network (PSTN) and a wireless circuit-switched network to facilitate traditional mobile communications.

The internetwork front ends 16 represent various devices capable of facilitating communications, and in particular, providing information, generally referred to as content, to circuit-switched devices served by the circuit-switched networks 14. The internetwork interfaces 16 may include, but are not limited to, a text interface 16A, an audio interface 16B, and a browser interface 16C. Each of these devices is configured to directly or indirectly receive information from a packet-switched device on the packet-switched network 12 and deliver information capable of being received and processed, directly or through intermediate devices, to circuit-switched devices on the circuit-switched networks 14. For the present description, it is assumed that the internetwork interfaces 16 cooperate with one or more wireless portals 18, which are capable of facilitating interaction with components on the packet-switched network 12.

The text interface 16A may be used to facilitate a variety of text-based messaging, including instant messaging, short message services (SMS), email, and the like to allow textual messages to be delivered to a variety of types of mobile terminals 20. Those skilled in the art will recognize the numerous techniques for sending text messages, which originate from the packet-switched network 12, to mobile terminals 20. The mobile terminals 20 may include cellular telephones 20A, personal digital assistants 20B, and wireless computing devices 20C, which are equipped with the necessary wireless modem or communication electronics to facilitate wireless communications.

In an effort to minimize the need to read information while traveling, the audio interface 16B may be used to provide audible messages to a user via the mobile terminal 20. The audible messages may be existing automated voice response systems driven by information provided from the packet-switched network 12, or a dedicated audio interaction device, such as an audio browser, which is described in greater detail later in the detailed description. Alternatively, the browser interface 16C is capable of supporting a browser running on the mobile terminal 20 and used to facilitate the requests for and delivery of content.

In addition to devices serviced by circuit-switched networks 14, wireless packet-switched mobile terminals 20D, such as packet-switched mobile telephones, may communicate with a traditional packet-switched network 12 via wireless packet-switched networks 24. In this case, information is communicated between the wireless packet-switched device 20D and devices on the packet-switched network 12 without conversion to a circuit-switched format. In addition to facilitating text, audio, and browser interfaces, the wireless packet-switched networks 24 can provide all of the user interaction functionality of the circuit-switched networks 14 and more.

In one embodiment of the present invention, an application server 22 residing in the packet-switched network 12 runs a process implementing a content delivery service capable of determining available parking for an automobile based on the location of a mobile terminal 20. The application server 22 may access location information from a variety of sources, including a location server 26, which may run a process capable of receiving or determining location information in a variety of ways. Although the location process could potentially run on the application server 22, a separate service provider may be used to provide a location determination service.

Location information may be derived from any number of sources, including an electronic mobile location center (EMLC), home or visitor location registers within a mobile network, or base station (or cell) locations and mobile terminals 20 themselves. In the latter case, electronics for receiving global positioning system (GPS) signals may be placed in the mobile terminals 20 wherein the information derived from the GPS signals is sent to the location server 26 for interpretation to identify the location of the mobile terminal 20. The location information may be an exact location or an area of interest associated with the relative position of the mobile terminal 20. Further, the direction of travel may be derived from sequential position measurements to refine the location information. Those skilled in the art will recognize the numerous location determining techniques capable of being used with the present invention.

The application server 22 can send the location information provided by the location server 26 to a spatial database server 28 configured to identify parking facility databases or servers 30 near the mobile terminal 20 in an area of interest based on the location information. For example, the spatial database server 28 can provide one or more uniform resource locators (URLs) for parking facilities based on the location information, which may include coordinates, proximities, or areas. Participating parking facilities will keep up-to-date parking information bearing on parking availability accessible to the application server 22 at one or more parking servers 30, which may serve one or more parking facilities. Customized profiles for a user may be established via the application server 22 and stored in a profile database 32, which may be integrated with or separate from the application server 22.

A user may log in to the application server 22 through any number of devices, including a personal computer 34, to-create a profile. Profiles can identify parking requirements and preferences as well as account and communication information. The parking requirements and preferences may relate to the size of the vehicle, acceptable parking costs, location, and available security. The account information may identify accounts and passwords to help facilitate automatic payment for parking and for the parking location service and related services provided by the application server 22. The account information may be associated with a credit or debit card and account. The communication information may be used to identify the delivery medium in which to send parking information to the mobile terminal 20.

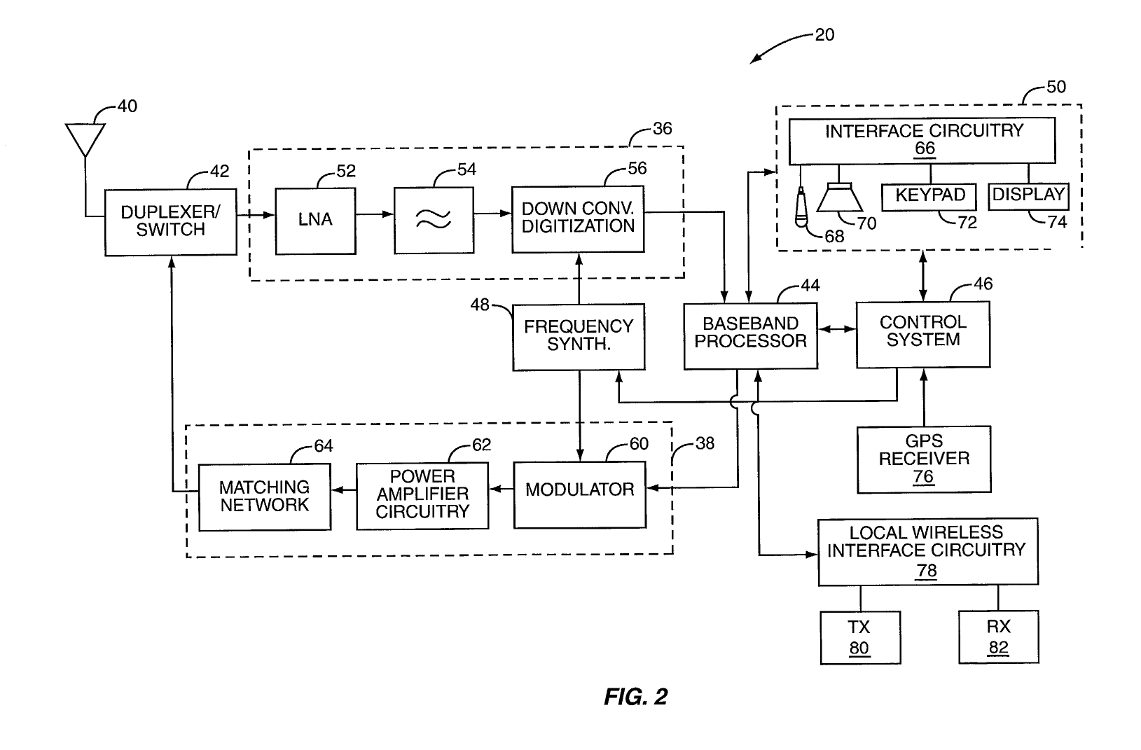

The basic architecture of a mobile terminal 20 is represented in FIG. 2 and may include a receiver front end 36, a radio frequency transmitter section 38, an antenna 40, a duplexer or switch 42, a baseband processor 44, a control system 46, a frequency synthesizer 48, and a user interface 50. The receiver front end 36 receives information bearing radio frequency signals from one or more remote transmitters provided by a base station. A low noise amplifier 52 amplifies the signal. A filter circuit 54 minimizes broadband interference in the received signal, while downconversion and digitization circuitry 56 downconverts the filtered, received signal to an intermediate or baseband frequency signal, which is then digitized into one or more digital streams. The receiver front end 36 typically uses one or more mixing frequencies generated by the frequency synthesizer 48.

The baseband processor 44 processes the digitized received signal to extract the information or data bits conveyed in the received signal. This processing typically comprises demodulation, decoding, and error correction operations. As such, the baseband processor 44 is generally implemented in one or more digital signal processors (DSPs).

On the transmit side, the baseband processor 44 receives digitized data, which may represent voice, data, or control information, from the control system 46, which it encodes for transmission. The encoded data is output to the transmitter 38, where it is used by a modulator 60 to modulate a carrier signal that is at a desired transmit frequency. Power amplifier circuitry 62 amplifies the modulated carrier signal to a level appropriate for transmission, and delivers the modulated carrier signal to antenna 40 through a matching network 64.

A user may interact with the mobile terminal 20 via the user interface 50, which may include interface circuitry 66 associated with a microphone 68, a speaker 70, a keypad 72, and a display 74. The interface circuitry 66 typically includes analog-to-digital converters, digital-to-analog converters, amplifiers, and the like. Additionally, it may include a voice encoder/decoder, in which case it may communicate directly with the baseband processor 44.

The microphone 68 will typically convert audio input, such as the user's voice, into an electrical signal, which is then digitized and passed directly or indirectly to the baseband processor 44. Audio information encoded in the received signal is recovered by the baseband processor 44, and converted by the interface circuitry 66 into an analog signal suitable for driving the speaker 70. The keypad 72 and display 74 enable the user to interact with the mobile terminal 20, input numbers to be dialed, address book information, or the like, as well as monitor call progress information.

The mobile terminal 20 may be equipped to receive and process GPS or like signals from which location can be derived. Accordingly, a GPS receiver 76 may be used to supply information sufficient to determine the relative location of the mobile terminal 20. Other location determining techniques capable of being housed in the mobile terminal 20 are equally applicable and the GPS illustration only serves to identify one widely known method readily recognizable by those skilled in the art.

In order to support a parking reservation system or facilitate payment, the mobile terminal 20 may be configured to directly or indirectly communicate with the parking facilities to provide confirmation information to verify reservations. Accordingly, the receiver front end 36 and radio frequency transmitter section 38 may also be configured to transmit radio frequency signals directly to a corresponding device at a parking facility to deliver identification, reservation, or accounting information, and receive radio frequency signals with related information. If the receiver front end 36 and radio frequency transmitter section 38 are not configurable to support local wireless communications, additional local wireless interface circuitry 78 may be provided in association with a transmitter (TX) 80 and receiver (RX) 82 to facilitate radio frequency communications, such as those used for Bluetooth applications, infrared, or like wireless communication techniques. In any case, the mobile terminal 20 may be configured to communicate with a device at the parking facility either directly or via the parking location application in the application server 22.

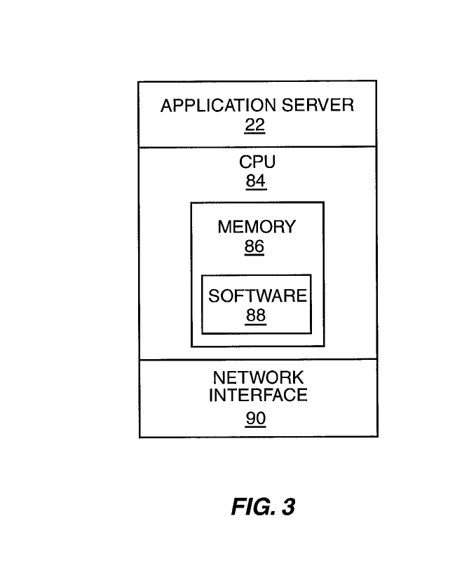

With reference to FIG. 3, the application server 22 will typically include a central processing unit (CPU) 84 having sufficient memory 86 containing the requisite software 88 for operation. The CPU 84 is associated with a network interface 90 to facilitate packet-switched communications with the various devices within and connected to the packet-switched network 12.

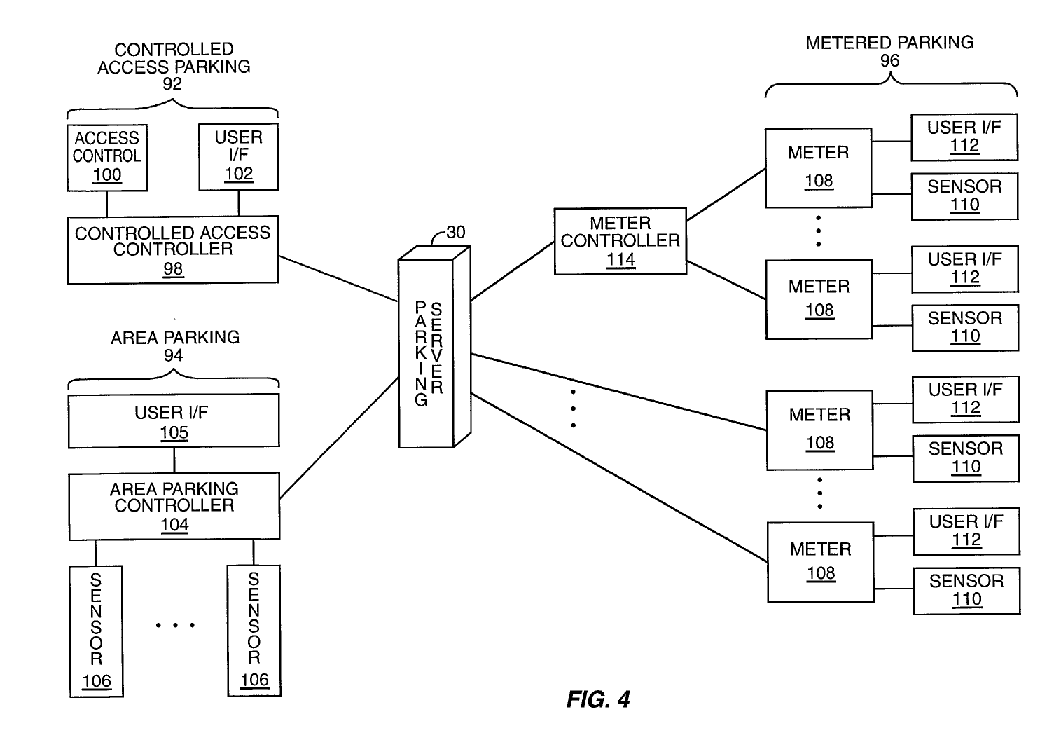

A few of the numerous types of parking facilities represented in FIG. 4 include controlled access parking 92, area parking 94 and metered parking 96. Controlled access parking 92 typically includes gated parking lots and garages and typically includes a controlled access controller 98 associated with an access control device 100, such as a gate, and a user interface 102. The user interface 102 may include a keypad to accept user input as well as a communication device compatible with the local wireless interface circuitry 78 of a mobile terminal 20 to facilitate local wireless communications. In one embodiment, the controlled access controller 98 keeps track of the available capacity, along with any characteristics of the capacity, and provides the information to the parking server 30.

Area parking 94 may include a variety of parking areas, including along streets or in lots, where available parking spaces can be identified in one way or another. An area parking controller 104 is preferably associated with multiple sensors 106 capable of detecting the presence of a vehicle in a parking space 106 and a user interface 105. The user interface 105 may be used by an attendant to enter information or by people parking to deposit coins or tokens as well as accommodate communications with compatible mobile terminals 20. Further, the user interface 105 may include a standard card reader for reading debit and credit cards. Alternatively, parking attendants can provide availability information through user interface 105 to the area parking controller 104, which will send availability information, determined automatically or manually, to the parking server 30.

Metered parking 96 typically provides a parking meter 108 for each parking space. Each meter may include a sensor 110 for determining the presence of a vehicle in the associated space and a user interface 112. The user interface 112 may be used to deposit coins or tokens as well as accommodate communications with compatible mobile terminals 20. To provide information bearing on the availability of a parking space associated with a meter 108, a meter controller 114 may be used to collect, assimilate, and provide availability information to the parking server 30. Alternatively, each meter 108 may be configured to directly communicate with the parking server 30 via the packet-switched network 12, which could be a wireless packet-switched network 24 allowing for the possibility of solar or battery powered, non-wired parking meters. In any case, the parking server 30 is able to obtain parking information bearing on the availability of parking spaces at one or more parking facilities.

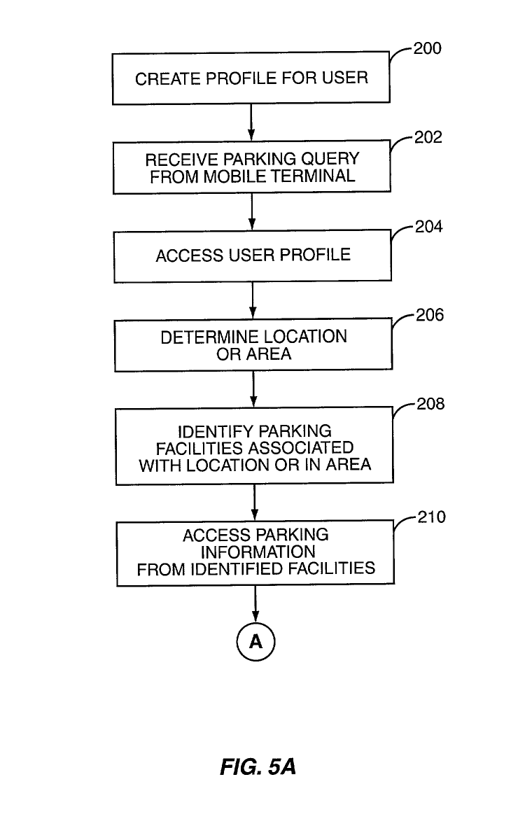

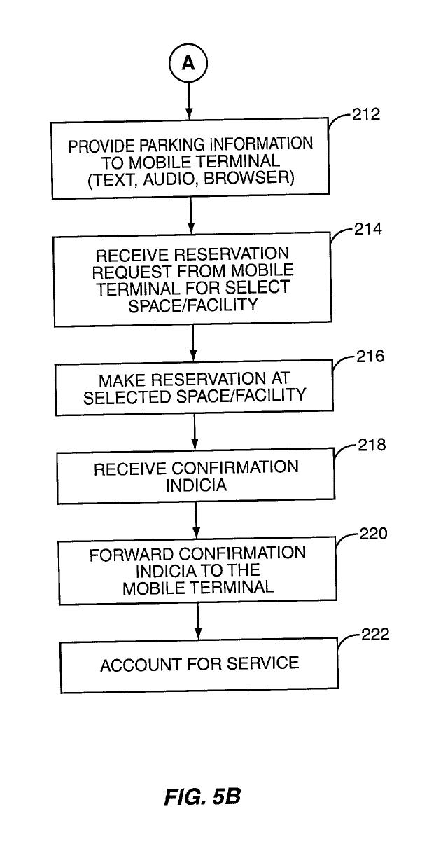

Turning now to FIGS. 5A and 5B, initially a user will log in to the application server 22 via a computer 34 or a mobile terminal 20 providing a browser interface or other appropriate user interface to create a profile, which is stored in the profile database 32 (step 200). The profile may include parking preferences, vehicle size, accounting information, mobile terminal identification, and any other information useful to the service provider to identify and select parking. During operation, the user will use the mobile terminal 20 to initiate a query to the application server 22, which will receive and process the query (step 202). From the query, the application server will identify the user, preferably from information related to the mobile terminal 20, and access the user's profile from the profile database 32 (step 204). Armed with the profile information, the application server 22 will determine the location of the mobile terminal 20 using the location server 26 (step 206). Depending on the configuration of the mobile terminal 20 and the supporting communication network, the location of the mobile terminal 20 can be determined in any number of ways. For example, a GPS-equipped mobile terminal 20 can provide internally determined location information with the query or in a separate communication to the application server 22. Accordingly, the application server 22 can pass the GPS information to the location server 26 for interpretation and determination of the location of the mobile terminal 20. The GPS information may be an estimated location or information for the location server 26 to determine an estimated position.

Alternatively, the wireless portions of the circuit-switched networks 14 can use triangulation or cell identification techniques to determine the location of the mobile terminal 20. Preferably, the location information is kept in or is otherwise made available to the location server 26 to allow identification of the location of the mobile terminal 20.

The location server 26 may be configured to expand the estimated location of the mobile terminal 20 into an area of interest about the mobile terminal 20. The area of interest is preferably sized and shaped to encompass a reasonable area in which to locate parking facilities. Creation of the area of interest is primarily controlled by the location server 26, but may be enhanced by information provided directly by the user or in the user's profile and selected to control the size or shape of the acceptable area of interest. The direction and speed of travel may be determined from sequential location estimates and may also impact the shape and size of the area of interest. Those skilled in the art will recognize numerous ways to define and fine-tune the estimated area of interest to optimize usefulness to the user and that the location server functionality could be combined in or involve a variety of network elements and not necessarily a standalone server function.

Assuming that the location server 26 returns an area of interest expanded about the mobile terminal's location, the application server 22 will subsequently identify parking facilities within the area of interest (step 208). Preferably, a query including the area of interest and, if applicable, any related profile information, will be sent to the spatial database server 28 to identify parking facilities within the area of interest and meeting any profile requirements. The identity of the parking facilities may be provided in any number ways including simply providing URLs for the parking server(s) 30 containing parking information for the selected parking facilities. Those skilled in the art will recognize that nothing requires that the spatial database server 28 be a separate network element and the functionality described could be integrated with other parking system functions as appropriate.

The application server 22 subsequently queries the identified parking server(s) 30 for the parking facilities to access parking information identifying available parking spaces (step 210). Preferably, the application server 22 and the parking server(s) 30 will use related profile information to identify only acceptable parking facilities having available parking spaces. The application server 22 will then provide the parking information identifying the available parking spaces to the mobile terminal 20 using the appropriate delivery medium (step 212).

In an enhanced system, the application server can cooperate with the parking server 30 and the mobile terminal 20 to reserve an available parking space at an acceptable parking facility. Accordingly, the information identifying available parking that is sent to the mobile terminal 20 can be configured to elicit a reply from the user to select a facility in which to reserve a parking space. As such, when a reservation request from a mobile terminal 20 is received (step 214), the application server 22 will make a reservation for the selected parking space or at a select facility (step 216). Preferably, the reservation is made via the supporting parking server 30, which will generate confirmation indicia, such as number or electronic token, to send to the application server 22 (step 218). Upon receipt of the confirmation indicia, the application server 22 will forward the confirmation indicia to the mobile terminal (step 220) and account for the service (step 222).

To fulfill the reservation, the confirmation indicia is supplied to the parking facility by the user or by the mobile terminal 20. In a simple embodiment, the confirmation indicia is a number provided to the user via the mobile terminal 20. The user can read or listen to the number from the mobile terminal 20 and then enter the number at the user interface of the parking facility. Alternatively, the mobile terminal 20 can directly or indirectly provide the confirmation indicia to the parking facility. For example, a mobile terminal 20 equipped with a local wireless interface could directly transmit the confirmation indicia to the parking facility or send the confirmation indicia to the parking facility through the packet-switched, circuit-switched, and/or wireless packet-switched networks 12, 14, 24. Further, the confirmation of the reservation may be coupled with payment for parking for parking using the account information provided in the user's profile or elsewhere in the system.

In one embodiment, audible content may be sent over circuit-switched networks 14 using an audio browser for the audio interface 16B. In general, the application server 22 and audio browser preferably operate in a client-server configuration using an audio- or voice-capable markup language. The audio browser will interpret the markup language content representing the audio message to send to the user and deliver the corresponding audio to the telephony user via the mobile terminal 20. If applicable, audio from the user is likewise converted to content for delivery to the application server 22. The messages sent to the user from the audio browser may be pre-recorded, generated in real-time based on text-to-speech conversion, or a combination thereof.

The voice extensible markup language (VoiceXML) is the preferred markup language for interaction between the audio browser and the application server 22. VoiceXML is an XML document schema developed by the VoiceXML Forum, a group of organizations founded by AT&T, IBM, Lucent Technologies, and Motorola. VoiceXML facilitates web-generated interactions through audio, either pre-recorded or translated from text to speech, and through voice, using speech recognition. Additional information on VoiceXML may be obtained from Motorola, Inc., 1303 East Algonquin Road, Schaumburg, Ill., 60196, or from the VoiceXML Forum, which has a web site at http://www.voicexml.org.

The audio browser, which may be referred to as a voice browser, is analogous to traditional, graphical browsers using HTML. The W3C working draft for “An Introduction and Glossary for the Requirement Draft Voice Browsers,” Dec. 23, 1999, provides additional information on voice browsers, and is incorporated herein by reference in its entirety.

As such, the audio browser is the liaison between the circuit-switched networks 14 and the application server 22 of the packet-switched network 12, and operates according to a call dialog established by the markup language. The call dialog is preferably provided to the audio browser in a VoiceXML web page created by the application server 22. The call dialog will preferably include the necessary information to interact with the user, and optionally, establish calls to and originated by the user, as well as report the status of the call or the user's response.

The application server 22 may generate the necessary call dialog in a VoiceXML page and provide the page to the audio browser. The audio browser will execute the call dialog to control communications with the user via the mobile terminal 20, as well as deliver audio to the mobile terminal corresponding to the information and/or content to deliver to the user or mobile terminal. The call dialog provided in the form of a VoiceXML page to the audio browser provides the audio browser with sufficient instructions to carry out its translational duties and control communications with the mobile terminal 20 to facilitate information delivery as described herein.

Thus, the audio browser provides text converted from audio to the application server 22 in the form of requests for web pages, and the responding web pages may include the text to convert and send to the user's mobile terminal 20 in an audible format. The VoiceXML pages will also include sufficient instructions to have the audio browser convert incoming audio and request subsequent pages to facilitate ongoing communications as desired. The call dialog provided in the VoiceXML pages may facilitate numerous iterations, instructions, and commands to effectively control the audio browser and the connection with the mobile terminal 20.

Those skilled in the art will recognize that all of the functions provided by the location server 26, spatial database server 28, and parking server 30 may be provided by the application server 22 or any number of network devices. Further, one can practice the invention without incorporating all of the described function. The inventive concepts of the present invention are defined by the claims and are not limited by the detailed embodiments described herein. Those skilled in the art will recognize improvements and modifications to the preferred embodiments of the present invention. All such improvements and modifications are considered within the scope of the concepts disclosed herein and the claims that follow.

What is claimed is:

1. A method for locating available parking comprising:
a) receiving a request initiated by a mobile terminal to identify available parking;
b) determining a location of the mobile terminal;
c) identifying the available parking based on the location of the mobile terminal; and
d) effecting delivery of parking information bearing on the available parking to the mobile terminal.

2. The method of claim 1 wherein the determining step includes expanding the location of the mobile terminal into an associated area of interest and the identifying step identifies parking areas or facilities within the area of interest and identifies the available parking at the parking areas or facilities within the area of interest.

3. The method of claim 2 further comprising determining a direction of travel for the mobile terminal and wherein the expanding step uses the direction of travel when creating the area of interest.

4. The method of claim 1 further comprising effecting delivery of directions associated with the available parking to a user via the mobile terminal.

5. The method of claim 1 further comprising effecting delivery of a map associated with the available parking to a user via the mobile terminal.

6. The method of claim 1 further comprising:
a) receiving a request initiated by the mobile terminal to reserve parking associated with the available parking; and
b) requesting a reservation associated with the available parking.

7. The method of claim 6 further comprising:
a) receiving confirmation for the reservation; and
b) delivering confirmation indicia based on the confirmation to the mobile terminal,
wherein the confirmation indicia can be provided to a parking area or facility providing the available parking to confirm the reservation.

8. The method of claim 7 further comprising delivering the confirmation indicia to the parking area or facility.

9. The method of claim 1 wherein the identifying step further comprises:
a) accessing a profile associated with the mobile terminal to access parking criteria defined by a user of the mobile terminal; and
b) selecting the available parking based on the parking criteria in the profile.

10. The method of claim 1 further comprising gathering information bearing on the availability of parking in at least one parking area or facility and from which the available parking is determined.

11. The method of claim 1 further comprising accounting for services associated with providing the parking information.

12. The method of claim 1 wherein communications with the mobile terminal are facilitated using one of the group consisting of text, audio, and browser based communication technologies.

13. A system for locating available parking comprising:
a) a network interface; and
b) a control system associated with the network interface and adapted to:
i) receive a request initiated by a mobile terminal to identify available parking;
ii) determine a location of the mobile terminal;
iii) identify the available parking based on the location of the mobile terminal; and
iv) effect delivery of parking information bearing on the available parking to the mobile terminal.

14. The system of claim 13 wherein the control system is further adapted to expand the location of the mobile terminal into an associated area of interest, identify parking areas or facilities within the area of interest, and identify the available parking at the parking areas or facilities within the area of interest.

15. The system of claim 14 wherein the control system is further adapted to determine a direction of travel for the mobile terminal and use the direction of travel when creating the area of interest.

16. The system of claim 13 wherein the control system is further adapted to effect delivery of directions associated with the available parking to a user via the mobile terminal.

17. The system of claim 13 wherein the control system is further adapted to effect delivery of a map associated with the available parking to a user via the mobile terminal.

18. The system of claim 13 wherein the control system is further adapted to:
a) receive a request initiated by the mobile terminal to reserve parking associated with the available parking; and
b) request a reservation associated with the available parking.

19. The system of claim 18 wherein the control system is further adapted to:
a) receive confirmation for the reservation; and
b) deliver confirmation indicia based on the confirmation to the mobile terminal,
wherein the confirmation indicia can be provided to a parking area or facility providing the available parking to confirm the reservation.

20. The system of claim 19 wherein the control system is further adapted to deliver the confirmation indicia to the parking area or facility.

21. The system of claim 13 wherein, to identify the available parking, the control system is further adapted to:
a) access a profile associated with the mobile terminal to access parking criteria defined by a user of the mobile terminal; and
b) select the available parking based on the parking criteria in the profile.

22. The system of claim 13 wherein the control system is further adapted to gather information bearing on the availability of parking in at least one parking area or facility and from which the available parking is determined.

23. The system of claim 13 wherein the control system is further adapted to account for services associated with providing the parking information.

24. The system of claim 13 wherein communications with the mobile terminal are facilitated using one of the group consisting of text, audio, and browser based communication technologies.

25. A computer readable medium providing software for locating available parking, the computer readable medium comprising instructions to:
a) receive a request initiated by a mobile terminal to identify available parking;
b) determine a location of the mobile terminal;
c) identify the available parking based on the location of the mobile terminal; and
d) effect delivery of parking information bearing on the available parking to the mobile terminal.

26. The computer readable medium of claim 25 comprising further instructions to expand the location of the mobile terminal into an associated area of interest, identify parking areas or facilities within the area of interest, and identify the available parking at the parking areas or facilities within the area of interest.

27. The computer readable medium of claim 26 comprising further instructions to determine a direction of travel for the mobile terminal and use the direction of travel when creating the area of interest.

28. The computer readable medium of claim 25 comprising further instructions to effect delivery of directions associated with the available parking to a user via the mobile terminal.

29. The computer readable medium of claim 25 comprising further instructions to effect delivery of a map associated with the available parking to a user via the mobile terminal.

30. The computer readable medium of claim 25 comprising further instructions to:
a) receive a request initiated by the mobile terminal to reserve parking associated with the available parking; and
b) request a reservation associated with the available parking.

31. The computer readable medium of claim 30 comprising further instructions to:
a) receive confirmation for the reservation; and
b) deliver confirmation indicia based on the confirmation to the mobile terminal,
wherein the confirmation indicia can be provided to a parking area or facility providing the available parking to confirm the reservation.

32. The computer readable medium of claim 31 wherein the control system is further adapted to deliver the confirmation indicia to the parking area or facility.

33. The computer readable medium of claim 25 comprising further instructions, when identifying the available parking, to:
a) access a profile associated with the mobile terminal to access parking criteria defined by a user of the mobile terminal; and
b) select the available parking based on the parking criteria in the profile.

34. The computer readable medium of claim 25 comprising further instructions to gather information bearing on the availability of parking in at least one parking area or facility and from which the available parking is determined.

35. The computer readable medium of claim 25 comprising further instructions to account for services associated with providing the parking information.

36. The computer readable medium of claim 25 wherein communications with the mobile terminal are effected using one of the group consisting of text, audio, and browser based communication technologies.

37. A system for locating available parking comprising:
a) means for receiving a request initiated by a mobile terminal to identify available parking;
b) means for determining a location of the mobile terminal;
c) means for identifying the available parking based on the location of the mobile terminal; and
d) means for effecting delivery of parking information bearing on the available parking to the mobile terminal.
